(19) United States
(12) Patent Application Publication
(10) Pub. No.: US 2005/0004836 A1
(43) Pub. Date: Jan. 6, 2005

(54) METHOD OF PROVIDING AN ELECTRONIC ADVERTISING SERVICE WITH LEASING OF ELECTRONIC ADVERTISING DISPLAYS

(75) Inventor: Mark Ruttenberg, Bloomington, IL (US)

Correspondence Address: BLACKWELL SANDERS PEPER MARTIN LLP, 720 OLIVE STREET, SUITE 2400, ST. LOUIS, MO, 63101, US

(73) Assignee: MONARCH ADVERTISING, INC., Normal, IL (US)

(21) Appl. No.: 10/709,330

(22) Filed: Apr. 28, 2004

Related U.S. Application Data
(60) Provisional application No. 60/466,162, filed on Apr. 28, 2003.

(51) Int. Cl. G06F 17/60; H04N 7/16; H04H 9/00

(52) U.S. Cl. 705/14

(57) ABSTRACT

An aspect of the present invention includes a method for providing electronic advertising within a retail outlet. The method includes leasing at least one electronic display to at least one retail outlet, providing a plurality of electronic advertisements to at least one processor via a network for display on the at least one electronic display, and obtaining revenue from at least one advertiser sponsoring the plurality of electronic advertisements. The advertising method can also include providing additional services including advertising sales support, advertising administrative services and advertising content production. Moreover, aspects of the electronic advertisements can be altered to increase effectiveness of the plurality of electronic advertisements that are displayed on the at least one electronic display.

### CROSS REFERENCE TO RELATED APPLICATIONS

This patent application claims priority to U.S. Provisional Patent Application Ser. No. 60/466,162 filed Apr. 28, 2003.

### BACKGROUND OF INVENTION

The retail outlets frequently use advertising displays throughout the store. Some advertising displays are preferably at or adjacent to the checkout counters to guarantee exposure to customers. Many advertising displays are of a type that are dedicated to one company or product. These advertising displays are sold or given to the retail outlets and the retail outlets typically do not charge for the display of advertising thereon. In some cases, the advertisements cannot be changed without approval and interaction with the entity providing the advertising display. The advertising may include advertising for store brands, store initiated advertising or the advertising may be requested and paid for by a manufacturer or supplier. Large retail outlets can afford to purchase the displays because of the volume of the sales they can achieve lowering the per customer or per purchase cost. Due to the amount of exposure to the public, the manufacturer or supplier of the products is willing to provide the advertisements. However, smaller stores may not have the cash flow or profits necessary to buy such advertising displays and the manufacturers or suppliers of the products may not deem the location desirable due to the small amount of public exposure.

Retail outlets and particularly grocery stores; operate on very thin or low margins. For example, grocery stores may only have a net profit of 2% of sales making the purchase of advertising displays uneconomical even though they can be used as a profit source.

The advantages of advertising of products are well known. It would be desirable to have advertising in a retail outlet including small outlets to enhance the sales of product and associated profits. However, in view of the costs of certain types of advertising displays, the use of expensive advertising displays may be prohibitive for smaller stores to purchase them for use. Thus, there is a need for an affordable method of providing advertising for retail outlets, small or large that is affordable and does not require a large cash outlay.

### SUMMARY OF INVENTION

The present invention relates to a method of providing instore advertising that will help enhance sales of products within the retail outlet. The method includes the provision of advertising displays to the retail outlet by a supplier on a lease or a lease-to-purchase basis. The retailer may charge an advertiser for the advertisement space. The advertisement space can be of a dynamic-type; e.g., an electronic panel device, which displays continually changing advertising messages on a screen and can have static displays as well. The electronic panel display is preferably connected to a data processing system such as a processor, which is operable to store the dynamic advertising message(s). The processor may be a centrally located computer, which can have stored data changed by the outlet, a home office or a service. The outlet, home office or service may also provide the generation of both the static and dynamic advertising messages. The supplier of the display units may, as part of the method, initially lease the advertising display units to a retail outlet and then sell the leases to a professional leasing company so that the manufacturer is not required to carry the lease obligations on its books or manage the leasing process for a long term. Selling a lease allows the advertising display supplier or manufacturer to be paid for its investment in the advertising display units and utilize profit from the sale of the lease to further conduct its business.

An aspect of the present invention includes a method for providing electronic advertising within a retail outlet. The method includes leasing at least one electronic display to at least one retail outlet, providing a plurality of electronic advertisements to at least one processor via a network for display on the at least one electronic display, and obtaining revenue from at least one advertiser sponsoring at least one electronic advertisement of the plurality of electronic advertisements.

Still another aspect of the present invention includes a method for providing electronic advertising within a retail outlet. This method includes leasing at least one electronic display to at least one retail outlet with a third party leasing company that owns the at least one electronic display, providing a plurality of electronic advertisements to at least one processor via a network for display on the at least one electronic display from a supplier, and obtaining revenue from at least one advertiser sponsoring the plurality of electronic advertisements.

Yet another aspect of the present invention includes a method for providing electronic advertising within a retail outlet. This method includes leasing at least one electronic display to at least one retail outlet, providing a plurality of electronic advertisements to the at least one processor via a network for display on the at least one electronic display, obtaining revenue from at least one advertiser sponsoring at least one electronic advertisement of the plurality of electronic advertisements, determining at least one product of the plurality of products that are being purchased by the at least one retail outlet, and altering at least one electronic advertisement of the plurality of electronic advertisements to increase effectiveness, wherein the altering of the electronic advertisement is selected from the group consisting of a type of the at least one electronic advertisement, timing of the at least one electronic advertisement, frequency of the at least one electronic advertisement and location of the at least one electronic advertisement within the at least one retail outlet.

These are merely some of the innumerable illustrative aspects of this present invention and should not be deemed an all-inclusive listing. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a perspective view of a preferred embodiment of an advertising display;

FIG. 2 is a top plan view of the advertising display as shown in FIG. 1;

FIG. 3 is a bottom plan view of the display unit as shown in FIG. 1;

FIG. 4 is a perspective, exploded view of the advertising display of FIG. 1 with the outer sleeve removed to show the structural details of the frame of the advertising display;

FIG. 5 is a rear elevational view of the advertising display of FIG. 1;

FIG. 6 is a front view of a laminated printed advertisement associated with the present invention;

FIG. 7 is a front elevational view of the advertising display associated with the present invention illustrating a bracket for supporting an electronic display panel;

FIG. 8 is a bottom view of the advertising display associated with the present invention illustrating a mount for attaching the advertising display to a pole;

FIG. 9 is an electrical schematic of a series of electronic display panels display associated with the present invention connected to a single processor;

FIG. 10 is a perspective view of an illustrative series of advertising displays utilized in an illustrative, but non-limiting, environment of a grocery store checkout stand;

FIG. 11 is a functional network diagram of a typical server environment in accordance with the present invention; and

FIG. 12 is a flowchart of a method of providing an electronic advertising service with leasing of electronic advertising displays associated with the present invention.

Like numbers throughout the various drawings designate like or similar parts or steps.

### DETAILED DESCRIPTION

In the following detailed description numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

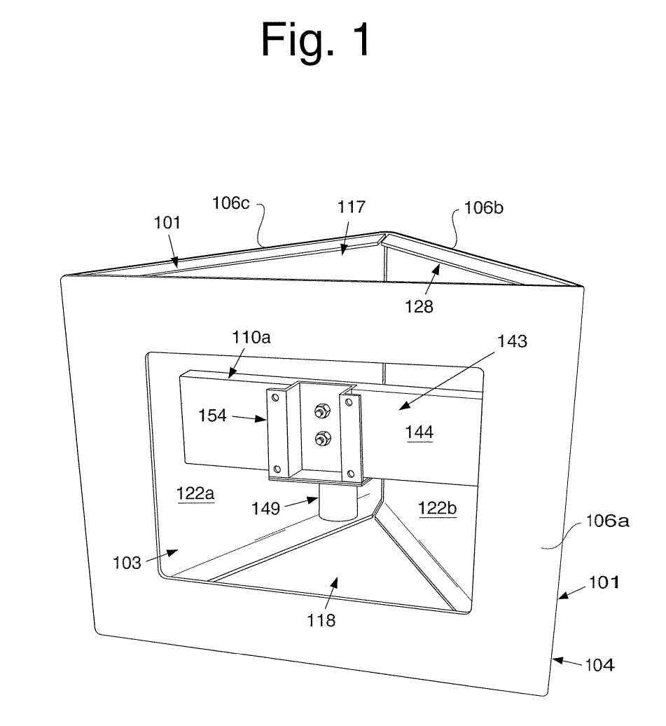

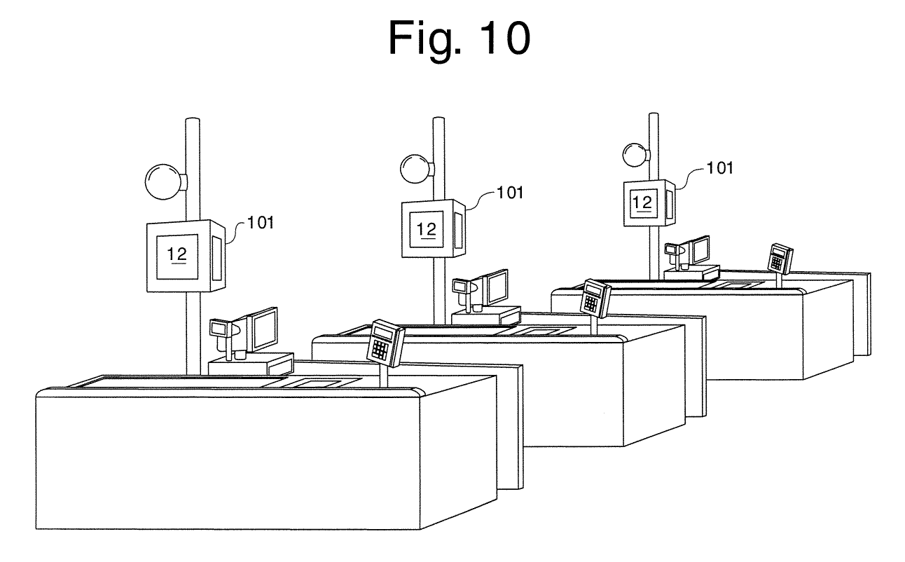

Referring now to the drawings, and initially to FIG. 1, which illustrates a preferred embodiment of an advertising display, which is generally indicated by numeral 101. Although the advertising display 101 can include a plurality of sides, i.e., polygonal design, the preferred design is a three-sided triangular design. Preferably, at least one side of the three-sided triangular design is an electronic panel display 12, as shown in FIG. 10.

Optimally, all sides of the triangular design for the advertising display 10 may be electronic panel displays 12. However, this is currently not the preferred embodiment solely due to cost considerations. The electronic panel display 12 is preferably a liquid crystal diode display (SGVA) with a display size of 1024×768 pixels. Although a liquid crystal diode display is preferred, cathode ray tube, plasma screen and other types of electronic panel displays 12 will suffice.

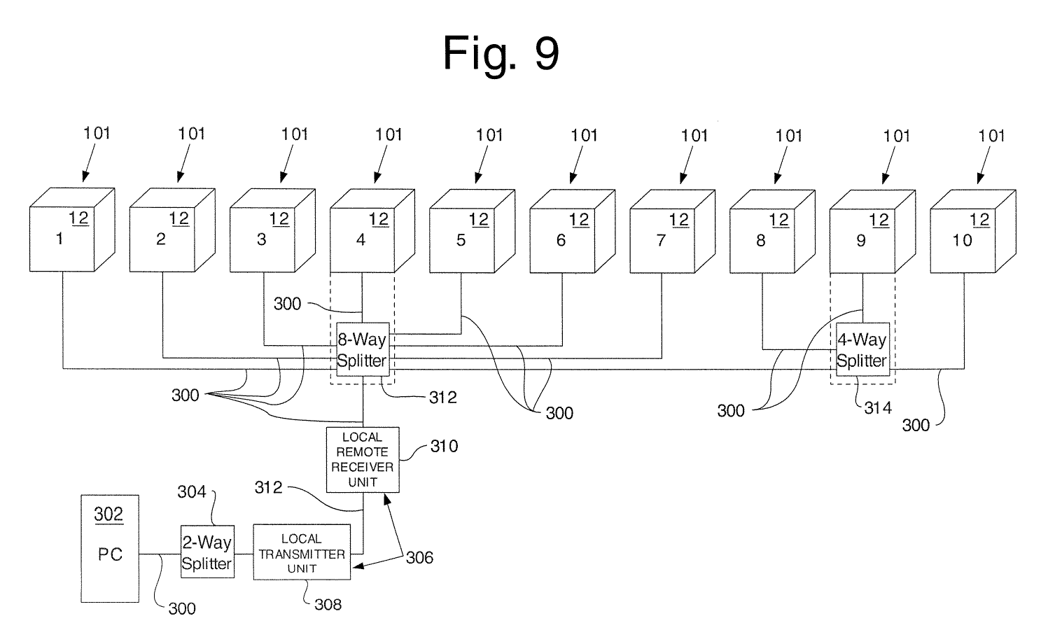

Electronic advertising can be supplied to the electronic panel display 12 from a wide variety of sources. The preferred mechanism for supplying electronic advertising to the electronic panel display 12 is by electrically connecting the electronic panel display 12 to a processor 302, as shown in FIG. 9, which receives advertising files and information via a data storage or a data transfer device such as utilizing a global computer network, e.g. Internet. The appropriate advertising is then downloaded by a particular processor 302 and is displayed within a particular panel on the electronic panel display 12. Each advertisement will be looped and reshown for a predetermined duration for a predetermined time interval that can flexibly altered from a remote location. Each processor 302 can receive new downloaded information at a predetermined time interval to delete existing advertisements from the system and download new advertisements.

A switch or push buttons can allow the customer viewing the display to go toggle back and forth between advertisements and replay those advertisements of particular interest. Advertisements can be used across the system or can be specific to a particular region or electronic panel display 12. A global computer system can provide additional information with searching capability for customers desiring more details about a particular product or service. This is fully described in International Patent Application No. PCT/US02/15377, entitled, “A Method and System for Displaying Advertising on an Electronic Display Screen,” which is incorporated herein by reference. International Patent Application No. PCT/US02/15377 was filed on May 15, 2002, and claims priority of U.S. Provisional Patent Application No. 60/291,065, which was filed on May 15, 2001. An example of an advertising instruction parameter file is listed below in Table 1:

TABLE 1
Advertisement Instruction Parameter

‘transition type = 1-8 compass direction 45 degree
clockwise 9 = zoom 99=random
‘scroll = 1-4 clockwise 90 degrees 1-100 100 = fastest
[FileName], [seconds to display], [transition type],
[order], [file size],
[fileID], [scroll direction 14],
‘[speed of scroll(in seconds across
panel)],‘[doNotShow true<>0], [tag file],
[Fullscreen
true<>0],
[Static Order
true<>0], [startDate], [endDate],
[startDayOfWeek], [endDayOfWeek],
[substituteAdName]
1 [seconds to display] seconds advertisement will
run
2 [transition type] ‘transition type = 1-8 compass
direction 45 degree clockwise 9 =
=zoom 99=random
3 [order] if this is omitted or duplicated the program
will fit it in unless Static Order
4 [file size] actual file size - checks against existing
or downloaded - if different the file is
deleted
5 [fileID] Not used
6 [scroll direction 1-4]
7[speed of scroll] seconds it takes for a marquee
to scroll across screen
8[donotshow] will not show file (used for tag and
substitute)
9[tagfile] file to show if third button pressed
10[FullScreen true<>0] shows the entire screen —
(over marquee)
11[Static order true<>0] forces order if listed to
be enforced
12[startDate[( ,startDate, startDate)]*
13[endDate[( ,endDate, endDate)]*
14[startDayOfWeek[( ,startDayOfWeek, startDay-
Ofweek)]*
15[endDayOfWeek[( ,endDayofweek, endDay-
OfWeek)]*
16[substituteAdName] advertisement to show if
this one doesn't
* substituteAdName must be separate file entry
* (donotshow = 1 will stop advertisement from being
in mix by itself)
“* NOTE 1. multiple dates, times, days can be
shown by separating by semicolons
i.e...” ,10/20/03;11/10/03,11/02/03;11/20/03
the above advertisement will run 10/20/03 thru
11/02/03 and again 11/10/03 thru
11/20/03
2. start and ends must have corresponding entries —
ends before start = ignore entry
3. days show in constraints of dates and or times
4. times shown without dates show every day unless
days dictate differently

Another method of electronically providing electronic advertising to the electronic panel display 12 also includes videotape players and DVD players and virtually any other type of device that can store visual information electronically for display on an electronic panel display 12. Also, satellite and wireless technology can be utilized. An example of using satellite technology with a global computer network, e.g., Internet, is disclosed in U.S. Pat. No. 6,105,060, entitled, “System for Providing Global Portable Internet Access Using Low Earth Orbit Satellite and Satellite Direct Radio Broadcast System,” which issued Aug. 15, 2000 to Rothblatt and is incorporated herein by reference. The advertisements can be sent by satellite and then decoded locally with a receiver associated with the electronic panel display 12. Each receiver can decode the appropriate advertising associated with a particular electronic panel display 12. The transmission of video content via satellite is disclosed in U.S. Pat. No. 6,111,611 issued to Ozkan et al. on Aug. 29, 2000, which is incorporated herein by reference.

The preferred embodiment of the advertising display of the present invention is generally indicated by numeral 101 in FIG. 1. The advertising display 101 includes an interior support structure 103 and an exterior shell 104. As shown, the shell 104 is sleeved onto the support 103 and is selectively movable relative to the support 103 in a longitudinal direction. The shell 104 is comprised, in the illustrated embodiment, of a plurality of display panels 106A, 106B and 106C which in number corresponds to the number of sides of the advertising display 101. In the illustrated structure, the advertising display 101 has three sides; however, it is to be understood that numerous other sides may be present but use of three sides for the advertising display 101 is the preferred embodiment. The panels or sides 106A, 106B and 106C are preferably formed from material that is both resilient and break-resistant material. An illustrative, but nonlimiting example, can include a polymeric material. A polymeric material can include a moderately expanded, rigid polyvinyl chloride (PVC) material with a high gloss satin finish. An example of this type of material includes SINTRA® available from Alcan Composites, USA Inc. located at 208 W. ₅^{th} Street, Benton, Ky. 42025-0507.

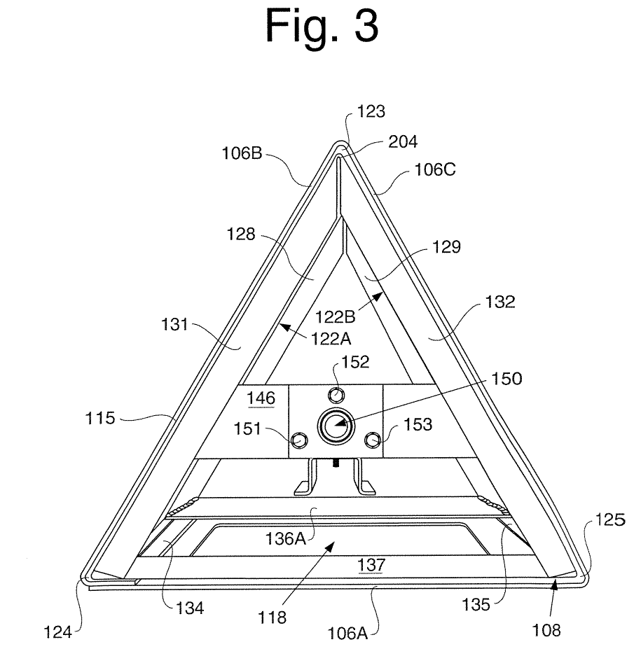

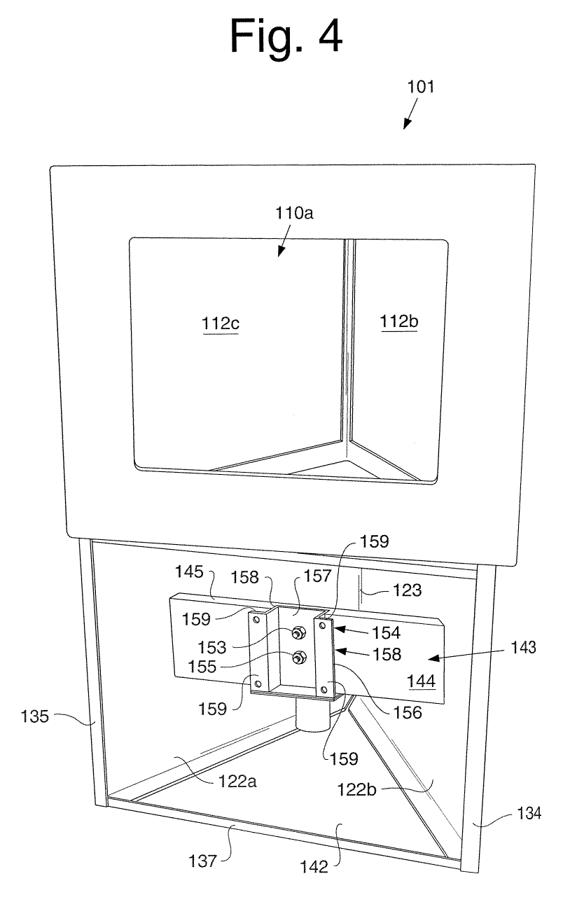

The shell 104 may be formed by any suitable method such as extrusion or may be formed from a flat panel and configured into a geometric shape, e.g., triangular cross-sectional shape, just by bending at the corners between the panels 106A, 106B and 106C and then joining the overlapping portions 108 as shown in FIGS. 3 and 4. This joining can be accomplished by a variety of chemical, thermal and mechanical processes, however, the preferred process includes adhesives. The adhesives utilized can be any of a wide variety of adhesives including, but not limited to, polyvinyl chloride (PVC) glues.

The transverse cross-sectional shape of the shell 104 is preferable generally uniform along the height of the shell 104 making it suitable for molding as by extrusion. As shown, each of the panels 106A, 106B and 106C, have a display opening 110A, 110B and 110C, respectively, therein. This is best shown in FIGS. 1, 4 and 5. The display opening 110A is a through opening and provides visual exposure to the screen of an electronic display panel 12, which is previously described above. Also, as best shown in FIG. 4, the shell 104 is provided with backing members 112B and 112C, which are secured behind opening 110B and 110C respectively. The backing members 112B and 112C are suitably secured to the panels 106B and 106C. This securing of the backing members 112B and 112C to the panels 106B and 106C can be accomplished by a variety of chemical, thermal and mechanical processes, however, the preferred process includes adhesives.

As with the panels or sides 106A, 106B and 106C, the backing members 112B and 112C are also preferably formed from material that is both resilient and break-resistant material. An illustrative, but nonlimiting example, can include a polymeric material. A polymeric material can include a moderately expanded, rigid polyvinyl chloride (PVC) material. An example of this type of material includes SINTRA® available from Alcan Composites, USA Inc. located at 208 W. 5^{th} Street, Benton, Ky. 42025-0507. Preferably the backing members 112B and 112C may be translucent or transparent for backlighting with a light, not shown.

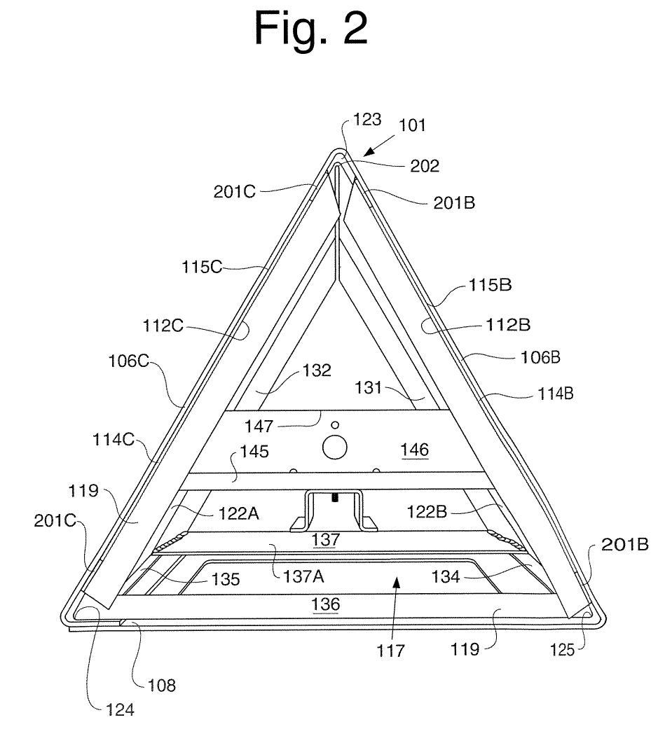

A gap 114B, 114C, as shown in FIG. 2, is provided preferably at the top of each panel 106B, 106C to allow the insertion of a laminated printed advertisement 5 into each pocket 115B, 115C formed between a panel 106B, 106C and the respective backing 112B, 112C. Preferably, a u-shaped frame 201B, 201C, as shown in FIGS. 2 and 3, can be utilized to support the laminated printed advertisement 5 and create the pocket 115B, 115C and well as the gap 114B, 114C. This u-shaped frame 201B, 201C can be attached to the panels 106B, 106C or made an integral part thereof. One illustrative, but nonlimiting, example of the type of material that can be utilized to create the frame is polymeric material. A polymeric material can include a moderately expanded, rigid polyvinyl chloride (PVC) material. An example of this type of material includes SINTRA®fix™ available from Alcan Composites, USA Inc. located at 208 W. 5^{th} Street, Benton, Ky. 42025-0507, which is exactly like the previously described moderately expanded, rigid polyvinyl chloride (PVC) material sold under the trademark SINTRA® with a high tack adhesive on one side. However, the u-shaped frame 201B, 201C can be attached to the panels 106B, 106C by a variety of chemical, thermal and mechanical processes with only the preferred process including adhesives.

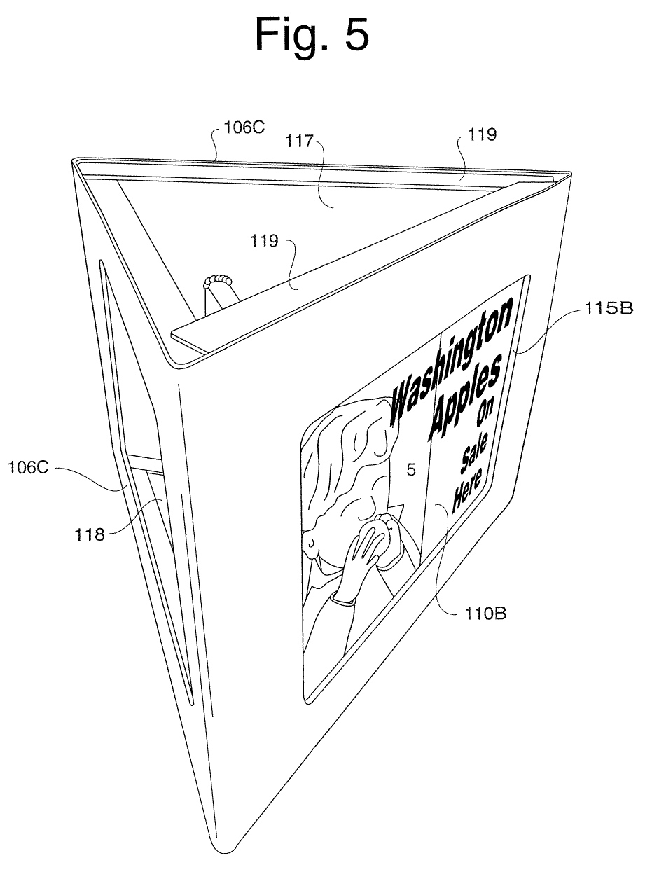

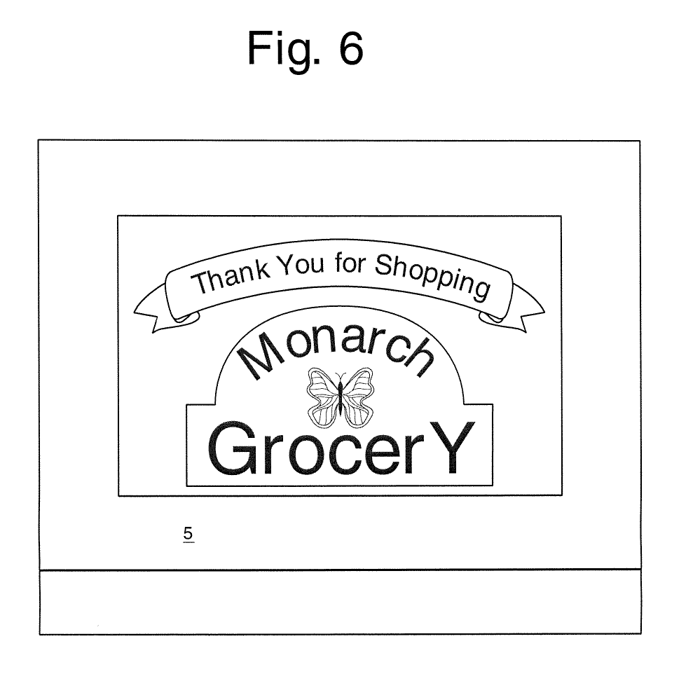

The printed advertisement 5, as also shown in FIG. 6, is thus viewable through a respective display opening 110B, 110C and yet is positively removably retained within a respective pocket 115B, 115C by having the advertisement 5 larger than the respective opening 110B, 110C, as shown in FIGS. 2 and 5. Both of the opposite ends 117, 118 of the shell 104 are open as shown in FIGS. 1 and 5. However, as best seen in FIG. 2, a plurality of stops 119 project into the interior of the shell 104 for engagement with an upper portion of the interior support 103 to limit longitudinal movement of the shell 104 relative to the support 103. The stops 119 are in the shape of a shoulder attached to each of the backing members 112B, 112C and preferably may be integrally formed therewith.

As shown in FIGS. 2-4, for the illustrative triangular embodiment, the interior support 103 has an exterior shape similar to the interior shape of the shell 104 to permit the shell 104 to be slidably received thereover. An illustrated, but nonlimiting, interior support 103 can include two wall members 122A and 122B that could be formed from one solid piece of metal that is formed at an angle, e.g., 60 degrees. A third side includes an upper support member 136 and a lower support member 137. The upper support member 136 and the lower support member 137 are preferably flanged. The interior support 103 can be made of a wide variety of materials such as metals, composites and plastics. However, the preferred material is lightweight aluminum.

The two wall members 122A, 122B, the upper support member 136 and the lower support member 137 are preferably joined at corners 123, 124 and 125, respectively, as shown in FIGS. 2 and 3. The corners 123, 124 and 125 are preferable generally parallel to one another. The wall members 122A and 122B are shown as being similar in construction and joined at the corner 123. Each of the two wall members 122A and 122B have an inwardly turned top flange 128, 129, respectively, and a bottom flange 131, 132, respectively, to help provide resistance to bending of the respective wall members 122A and 122B. It is preferred that the wall members 122A and 122B be made out of a single piece of material wherein the corner 123 is a integral portion of both of the walls and can be formed by simply bending a sheet of material after forming a top notch 202 between the top flanges 128 and 129, as shown in FIG. 2, and forming a bottom notch 204 between the bottom flanges 128 and 129, as shown in FIG. 3.

As shown in FIGS. 2 and 3, the wall member 122A has an inwardly turned longitudinally extending flange 134 and the wall member 122B has a similarly formed flange 135. The flanges 134, 135 preferably may be an integral part of the respective wall members 122A and 122B and formed by bending or turning inwardly of the material comprising the walls to provide structural resistance. The flanges 134, 135 may also be separate components fixedly attached thereto by welding, adhesives or other suitable means of attachment.

The upper support member 136 and the lower support member 137 are preferably positioned at the top and bottom respectively of the panel 106A, and are in the form of angle members each with a respective flange 136A and 137B, respectively, that are parallel to one another forming a face for the panel 106C. The flanges 136A, 136B may also be separate components fixedly attached thereto by welding, adhesives or other suitable means of attachment, as shown in FIG. 2.

As shown in FIGS. 1 and 5, the interior of the support 103 is generally hollow. It is preferred that the support 103 have opposite top and bottom ends 117, 118 respectively that are open to provide access to the interior of the support 103 for example to secure the support 103 to a center pole (not shown) and for facilitating attachment of the electronic panel display 12 to the support 103.

As shown in FIG. 1, a support brace 143 is secured to and extends between the wall members 122A and 122B. The support brace 143, which is generally described as a u-shaped channel, includes an upstanding wall 144 with a right angle flange 145 at the top extending away from the panel 106A, as shown in FIG. 4. As shown in FIG. 2, there is an inturned flange 146 at the bottom of the wall 144, which extends away from the panel 106A and generally parallel to the flange 145. At the rear edge 147 of the flange 146 there is an upturned flange 147 that is generally parallel to the wall 144.

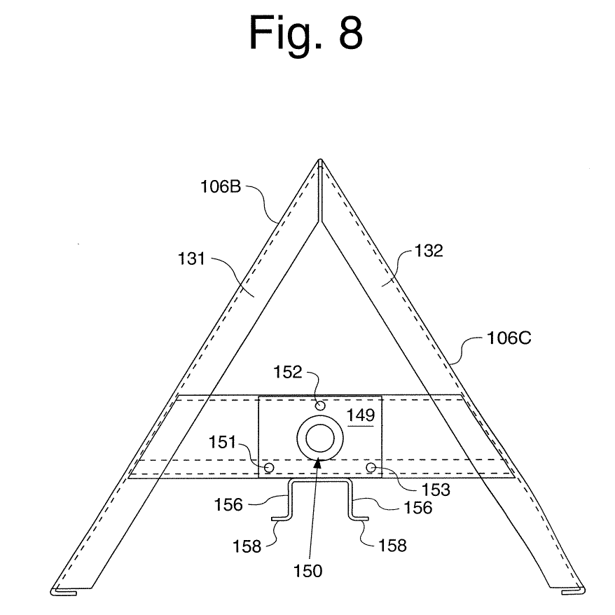

A mount 149 is secured to the inturned flange 146 and has a threaded hole 150 for mounting of the display 101 on a pole (not shown). Although a threaded cooperative engagement between the pole (not shown) and mount 149 is shown, other forms of mounting may be provided for example a set screw may be provided and a hole may be a blind hole to limit longitudinal movement of the pole (not shown) into the mount 149. The mount 149 may be secured to the support brace 143 by a variety of chemical, thermal and mechanical processes with only the preferred process including utilizing cooperatively inter-engaging nut and bolt combinations 151, 152 and 153, as shown in FIGS. 3, 7 and 8 may be used. The longitudinal axis of the threaded hole 150 is generally vertical when the advertising display 101 is in its mounted position for display.

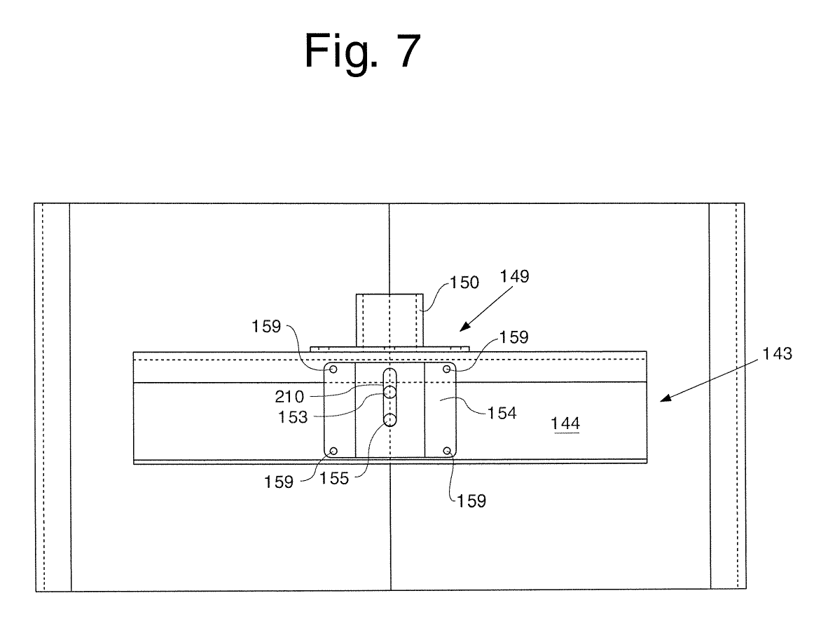

A bracket 154 for mounting the electronic panel display 12 can be secured to the wall 144 of the support brace 143 by a variety of chemical, thermal and mechanical processes with the preferred process including utilizing cooperatively inter-engaging nut and bolt combinations 153 and 155 that can also include washers. There is preferably an oval groove 210 in the upstanding wall 144 so that the position of the bracket 154 can vary longitudinally within the advertising display 10 as shown in FIGS. 4 and 7. As shown, the bracket 154 generally in the form of a u-shaped channel with opposed and outwardly projecting flanges 156. The bracket 154 has a bight portion 157 with legs 158 extending from each of the longitudinal side edges of the bight 157. The flanges 156 in turn project from the free end of the legs 158. The flanges 156 may be provided with apertures 159 for the receipt of suitable fasteners such as screws for attaching the electronic panel display 12 to the bracket 154 and hence to the advertising display 101. The display screen of the electronic display 12 is exposed to a consumer through an opening in the panel 106A. The bracket 154 for mounting the electronic panel display 12 preferably conforms to a standard set forth by the Video Electronics Standards Association. The standard for mounting holes at 75 millimeters by 75 millimeters is adaptable for most electronic panel displays 12.

The preferred electrical wiring schematic for multiple store advertising displays 101 includes connecting a number of electronic panel displays 12 that are associated with advertising displays 10 throughout the desired establishment, e.g., each checkout lane in a grocery store. In the preferred, illustrative but nonlimiting embodiment, the processor 302 is electrically connected via VGA cable 300 to a two-way splitter 304 then to a video extender kit 306 via VGA cable 300. The video extender kit 306 allows an extension of the distance between the processor 302 and the electronic panel displays 12 by hundreds of feet. This is accomplished by a local transmitting unit 308 and local remote receiving unit 310 connected by standard Category Five (5) twisted pair Ethernet cable 312. The VGA cable 300 provides for transmission of video/data signals having a wide bandwidth. In this illustrative embodiment, there is both an eight-way splitter 312 and a four-way splitter 314 to provide the video to the illustrative ten (10) electronic panel displays 12. An example of a perspective view of a number of checkout lanes each having an advertising display 101 with a preferred, but not necessary, electronic panel display 12 is shown in FIG. 10.

The advertising display 101 is connected to the processor 302, shown schematically in FIGS. 9 and 10, for receipt of advertising data therefrom. The processor 302 may be a computer that includes a data storage component such as a hard drive for storing the advertising data thereon. The stored data may be shown on the electronic panel displays 12 in a loop fashion with various advertisements being run for a period of time and then changed to another advertisement with the multiple advertisements eventually recycling, if desired, on the electronic panel displays 12.

Each of the advertising displays 101 may have a electronic panel display 12, or may have a static advertisement, for example, a laminated printed advertisement 5, which may be easily exchanged by store personnel. In the illustrated embodiment, the advertising display 101 includes one electronic panel display 12 (to show one or more dynamic ads) and two static ads, e.g., laminated printed advertisements 5, and is generally triangularly shaped in transverse cross section. The advertising display 101 may be pivotable to achieve the desired viewing angles of the advertisements by consumers, e.g., the electronic panel display 12 may be directed so that the customer checking out may view dynamic advertisement material or the display screen may be pointed away from the checkout counter so that the people waiting in line may view the dynamic advertisement material. The advertising display 101 may also be rotatable.

The processor 302 may be located on premises at the outlet, at a remote site; e.g., at an office for a chain of retail outlets, at the supplier of the electronic panel displays 12 or at another third party location for the maintenance of the advertising materials, the changing of the advertising materials and the creation of advertising materials.

As seen, a supplier provides to a retail outlet one or more advertising displays 101. The supplier may be a manufacturer, distributor, vendor or broker. Preferably, the supplier is an advertising organization that can provide assistance to the retail outlet to develop both advertising content as well as the logistics involved in sales of advertising and administration. The supplier or other party will effect a lease arrangement or a lease to purchase arrangement with the retail outlet. The retail outlet may be a single store or a group of stores and may be operated under a single name or multiple names. The stores may be franchised, independent or commonly owned.

The lease arrangement may include multiple lease payments payable from the outlet or an outlet's affiliate, to the supplier from time to time and preferably periodically. The supplier may transfer the lease, as for example, by sale to a third party leasing agent who will then reimburse the supplier for some value or discounted value of the lease, which value should exceed the cost or price (which is calculated preferably by or for the supplier) of the advertising display 101 or advertising displays 101 plus some value or discounted value for the ongoing payment streams under the lease. The value or discounted value is preferably calculated by or for the supplier and/or third party leasing agent.

The advertising displays 101 are then installed at the retail outlet or outlets and positioned in accordance with the retail outlet's desire for viewing by consumers. Subsequent repositioning may also be effected. For example, an advertising display 101 may be positioned at the checkout counters for viewing when a customer enters a store or at various locations throughout the retail outlet for exposure during shopping. For example, an advertisement may be shown for flour. The advertising display 101 may be positioned at the flour section or adjacent the flour section. The orientation of the advertising display 101 may be changed as desired. The advertising display 101 is connected to a processor 302 where the processor 302 may be built in the advertising display 101, remote from the advertising display 101 but on the retail outlet's premises, or may be remote from the retail outlet. The processor 302 will have stored therein data, preferably in digital form, which when transmitted to the electronic panel display 12 by a VGA cable 300, will show one or more advertisements. Preferably, multiple advertisements are shown in sequence with the advertisements looping after some or all the advertisements have been played. For example, if ten (10) advertisements are contained in the processor 302 for display, the advertisements may be shown in the sequence of the first through the tenth advertisement and after the tenth advertisement is shown, the advertisements will be shown again in the sequence that they were shown in originally. The processor 302 may also be programmed to show the advertisements randomly. The processor 302 may only store one advertisement, for example, a flour advertisement that could be shown repeatedly at the flour section or elsewhere. The retail outlet or third party may approach potential advertisers to sell advertisement space or time, as either dynamic advertisement space and/or static advertisement space.

A person such as the supplier representative or outlet representative will calculate and/or negotiate a price for the advertisement space that will preferably cover the cost of the lease payments by the retail outlet and be acceptable to at least one of the parties. The retail outlet will then lease the advertisement space as desired, determine the length of the time the advertisement will run, the frequency the advertisement will run, all acceptable to the advertiser(s). The retail outlet, the advertiser, the supplier or a third party will develop the advertisement content and supply it to a party who will construct the advertisement and either provide it in static form or in electronic form (preferably in digital format). In the latter event, the electronic form will then be sent to and stored in the processor 302 and preferably in digital form. The electronic or digital version of the advertisement will then be transmitted to the electronic panel display 12 for display as predetermined either in a repeating loop mode of playing, random playing, or any other form of playing as determined between the parties.

The retail outlet will pay the lease payment to either the supplier or the third party leasing agent as predetermined. The retail outlet may provide not only advertisement space for third parties, but may also provide advertisement space for itself calculating a value of those advertisements into the price it is willing to pay for a lease arrangement or a lease-to-purchase arrangement. The supplier may provide additional service in addition to the hardware, content or advertisement materials and the software. The supplier may also provide to personnel of the retail outlet a referral to potential clients or advertisers for the retail outlet, provide training for the retailer on how to sell advertisement space or time, provide telemarketing services and provide advertisement preparation services.

The lease, lease-to-purchase and lease sale arrangements between the parties may also provide for a share in the advertising proceeds to be paid to a person such as the leasing agent or the supplier. Such an arrangement may result in a reduction in the fixed price of the lease with a supplier or leasing agent hoping for a higher return than a fixed leased payment by sharing in the proceeds.

This present method of and system for advertising may also, through the gathering of data, provide valuable marketing information to the retail outlet, advertiser or other interested party. For example, through the use of Universal Product Code (UPC) based purchase data, which is readily available now in retail outlets. The Universal Product Code (UPC) is a unique 12-digit number assigned to retail merchandise that identifies both the product and the vendor that sells the product. The UPC on a product typically appears adjacent to its bar code, the machine-readable representation of the UPC. The first six digits of the UPC are the vendor's unique identification number. All of the products that one vendor sells will have the same first six digits in their UPCs. The next five digits are the product's unique reference number that identifies the product within any one vendor's line of products. The last number is called the check digit that is used to verify that the UPC for that specific product is correct.

Therefore, the purchase of product may be coordinated to and analyzed in accordance with the advertisements being run, the timing of the advertisements, the frequency of the advertisements and the location of the advertisements within the outlet. The computer may also provide data on growth or decline in sales, either coordinated to the advertising data, or not coordinated to the advertising data. The data may be used to test the effectiveness of a specific advertisement, the location of the viewing of the advertisement to help maximize, optimize or increase the sales of products to the gathered marketing information. The analyses can help provide or verify the effectiveness of an advertisement, its location of display and/or the advertisement content.

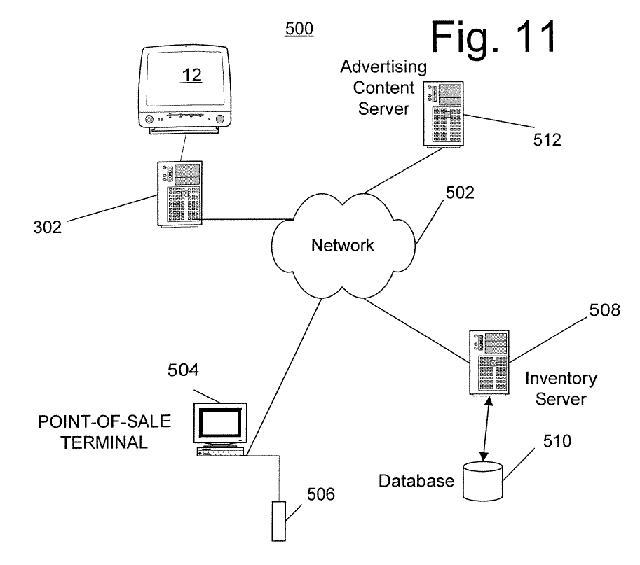

Referring to FIG. 11, a functional network diagram of a typical environment 500 implementing the present invention is shown. As shown, a network 502 may have various connected components including an electronic panel display 12 connected to the processor 302 that is capable of receiving advertising content via the network 502. There is an inventory server 508 connected to a database 510 that is connected to the network 502. There is a point-of-sale terminal 504 used for creating sales transactions and is electrically connected to an electronic identification mechanism, e.g., universal product code (UPC) reader, 506 that is capable of determining what products are being sold by reading the UPC on each product as discussed above. This information is passed to the inventory sever 508 to change the inventory listed in the database 510. This information can be provide to the network 502 and passed to an advertising content server 512 so that the content of the electronic advertising provided to the electronic panel display 12 can be altered based on the effectiveness of the advertising.

This environment 500 should not be interpreted as having any dependency or requirement relating to any one or a combination of components illustrated in the exemplary operating environment. The network 502 may include a local area network (LAN), a wide area network (WAN) or other networks including a global computer network, e.g., Internet. It will be appreciated that the network 512 shown is exemplary and other means of establishing a communications link between the computing devices may be used. The illustrated devices and components may also be connected through wireless interfaces without departing from the scope of the present invention. Those of ordinary skill in the art will also appreciate that there are several other components and interconnections present within a computing environment. Accordingly, additional details concerning the internal construction of the networked computing devices will not be discussed in connection with the present invention.

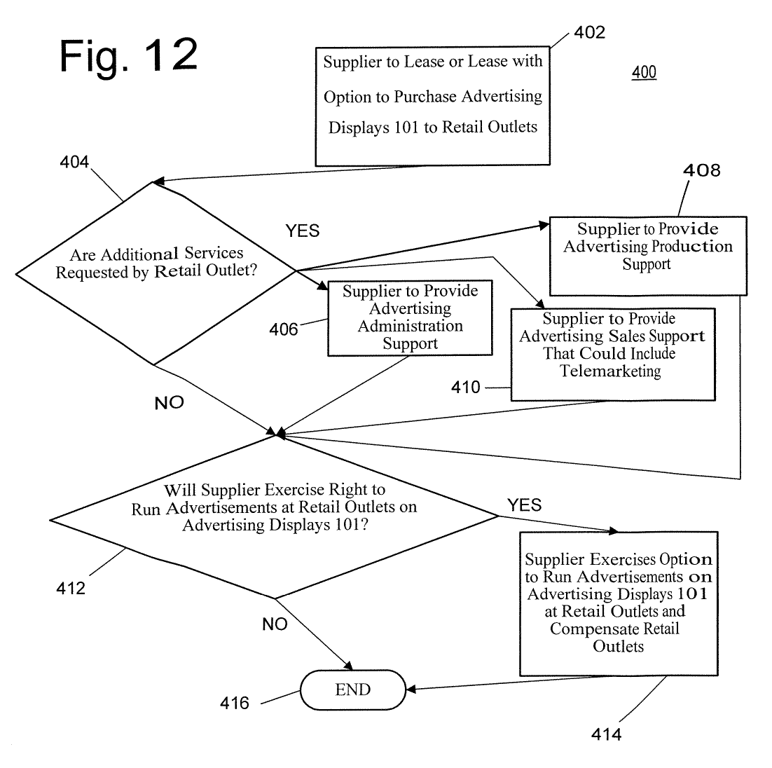

In the description of flowcharts, the functional explanation marked with numerals in angle brackets, <nnn>, will refer to the flowchart blocks bearing that number. Referring now to FIG. 12, which illustrates the process steps involved with the present invention and is generally indicated by numeral 400. The first step in the process is for the supplier to lease or lease with an option to purchase the advertising display 101 to a retail outlet <402>. The advertising display 101 preferably, but not necessarily includes an electronic display panel 12 connected to a processor 302. The proprietary software utilized on the processor 302 would only be licensed to the retail outlet and not sold. The next step in the process is to determine if any additional services are requested by the retail outlet from the supplier <404>. If the answer to this query is affirmative, the additional services can include providing administrative support <406>. This administrative support can include, but is not limited to, sending out invoices to the advertisers for the retail outlets, receiving the funds from advertisers and tabulating and forwarding these funds to the retail outlets. Also, the additional services can include providing advertising sales support <410>. This can include, but is not limited to, assisting potential advertisers in signing on with the service. This can include, but is not limited to use of a toll-free number directed to the supplier, providing detailed information and brochures to potential advertisers, training representatives from a retail outlet in selling advertising, and so forth. Another option that the supplier could perform telemarketing activity regarding the advertising displays 101 and charge the retail outlets accordingly for this activity. Moreover, the additional services can include providing advertising production support <408>. This can include, but is not limited to, creating camera-ready art-work to be scanned by the supplier or the supplier can create the advertisements. As a promotional, the initial advertisements created by the suppler can be provided to the retail outlets at little or no cost. Advertising production costs can be charged based on production time that is preferably, but not necessarily, capped at a predetermined maximum dollar amount. Charges for revisions, scanning or camera-ready artwork and other services can be provided by the suppler in the production of advertisements.

The next step in the process is whether the supplier will exercise any rights to show advertisements on the advertising displays 101 <412>. If the answer is negative, the process can end <416>. If the answer is positive, the supplier can exercise the option and run his or her advertisements on the advertising displays 101 at the retail outlet and compensate the retail outlet accordingly <414>. This again will end the process <416>.

Thus, there has been shown and described a novel method for leasing advertising displays 101 at a retail business. Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention. A portion of the disclosure of this patent document contains material, which is subject to copyright protection. The copyright owner has no objection to the facsimile reproduction by any one of the patent document or the patent disclosure as it appears in the Patent and Trademark Office, Patent file or records, but otherwise reserves all copyright rights whatsoever.

1. A method for providing electronic advertising within a retail outlet comprising:
leasing at least one electronic display to at least one retail outlet;
providing a plurality of electronic advertisements to at least one processor via a network for display on the at least one electronic display; and
obtaining revenue from at least one advertiser sponsoring at least one electronic advertisement of the plurality of electronic advertisements.

2. The method for providing electronic advertising within a retail outlet as set forth in claim 1, wherein the leasing of the at least one electronic display is provided by a third party leasing company who owns the at least one electronic display.

3. The method for providing electronic advertising within a retail outlet as set forth in claim 1, wherein the leasing of the at least one electronic display is selected from the group consisting of a leasing agreement, a lease-to-purchase agreement, and a lease sale agreement.

4. The method for providing electronic advertising within a retail outlet as set forth in claim 1, wherein the providing of a plurality of electronic advertisements to at least one processor via a network for display on the at least one electronic display is through a supplier.

5. The method for providing electronic advertising within a retail outlet as set forth in claim 4, wherein the leasing of the at least one electronic display is provided by the supplier.

6. The method for providing electronic advertising within a retail outlet as set forth in claim 4, wherein the supplier selected from the group consisting of a manufacturer, a distributor, a vendor and a broker.

7. The method for providing electronic advertising within a retail outlet as set forth in claim 4, wherein the supplier includes an advertising organization.

8. The method for providing electronic advertising within a retail outlet as set forth in claim 7, wherein the advertising organization provides advertising content production.

9. The method for providing electronic advertising within a retail outlet as set forth in claim 7, wherein the advertising organization provides advertising administration and logistics in advertising sales.

10. The method for providing electronic advertising within a retail outlet as set forth in claim 7, wherein the advertising organization provides telemarketing support.

11. The method for providing electronic advertising within a retail outlet as set forth in claim 7, wherein the supplier can exercise a right to run advertisements on the at least one electronic display and compensate the at least one retail outlet accordingly.

12. The method for providing electronic advertising within a retail outlet as set forth in claim 1, further comprising:
determining at least one product that is purchased by the at least one retail outlet; and
altering at least one electronic advertisement of the plurality of electronic advertisements to increase effectiveness of the plurality of electronic advertisements that are displayed on the at least one electronic display.

13. The method for providing electronic advertising within a retail outlet as set forth in claim 12, wherein the determining at least one product that is purchased by the at least one retail outlet includes reading information from at least one universal product code from the at least one product.

14. The method for providing electronic advertising within a retail outlet as set forth in claim 13, wherein the reading information from at least one universal product code is performed with at least one electronic identification mechanism and provided to an inventory server that includes an associated database.

15. The method for providing electronic advertising within a retail outlet as set forth in claim 12, wherein the altering at least one electronic advertisement of the plurality of electronic advertisements to increase effectiveness of the plurality of electronic advertisements is selected from the group consisting of a type of the at least one electronic advertisement, timing of the at least one electronic advertisement, frequency of the at least one electronic advertisement and a location of the at least one electronic advertisement within the at least one retail outlet.

16. The method for providing electronic advertising within a retail outlet as set forth in claim 12, further comprising:
locating the at least one electronic display from the group consisting of a location wherein at least one product is located within the at least one retail outlet; and
a point of sale location for the at least one product within the at least one retail outlet.

17. A method for providing electronic advertising within a retail outlet comprising:
leasing at least one electronic display to at least one retail outlet with a third party leasing company that owns the at least one electronic display;
providing a plurality of electronic advertisements to at least one processor via a network for display on the at least one electronic display from a supplier; and
obtaining revenue from at least one advertiser sponsoring the plurality of electronic advertisements.

18. The method for providing electronic advertising within a retail outlet as set forth in claim 17, wherein the supplier selected from the group consisting of a manufacturer, a distributor, a vendor, a broker and an advertising organization.

19. The method for providing electronic advertising within a retail outlet as set forth in claim 17, wherein the advertising organization can provide services selected from the group consisting of providing advertising content production, providing logistics in advertising sales, providing advertising administration and providing telemarketing support.

20. A method for providing electronic advertising within a retail outlet comprising:
leasing at least one electronic display to at least one retail outlet;
providing a plurality of electronic advertisements to the at least one processor via a network for display on the at least one electronic display;
obtaining revenue from at least one advertiser sponsoring at least one electronic advertisement of the plurality of electronic advertisements;
determining at least one product of the plurality of products that are being purchased by the at least one retail outlet; and
altering at least one electronic advertisement of the plurality of electronic advertisements to increase effectiveness, wherein the altering of the electronic advertising is selected from the group consisting of a type of the at least one electronic advertisement, timing of the at least one electronic advertisement, frequency of the at least one electronic advertisement and location of the at least one electronic advertisement within the at least one retail outlet.
